(19) United States
(12) Patent Application Publication
(10) Pub. No.: US 2008/0094321 A1
(43) Pub. Date: Apr. 24, 2008

(54) ORGANIC LIGHT EMITTING DIODE DISPLAY AND METHOD OF MANUFACTURE

(76) Inventors: Kyong-Tae PARK, Uijeongbu-si (KR); Chang-Mo Park, Seoul (KR); Ji-Hye Choi, Yongin-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/874,657

(22) Filed: Oct. 18, 2007

(30) Foreign Application Priority Data
Oct. 20, 2006 (KR) 10-2006-0102546

(51) Int. Cl. G09G 3/30; H01J 1/02

(52) U.S. Cl. 345/76; 445/24

(57) ABSTRACT

An organic light emitting diode display includes a display region where a plurality of thin film transistors and a plurality of emission layers are formed, and a peripheral area formed along the circumference of the display area; a flexible conductive film that includes contact portions, each of which is formed on the corresponding anisotropic conductive film, has a conductive layer and an insulating layer covering the conductive layer, and has substantially the same layout as the voltage pads; an anisotropic conductive film that is formed on the voltage pads; and voltage pads that are formed in the peripheral area and that apply at least one of a driving voltage and a common voltage to the display region.

### CROSS-REFERENCE TO RELATED APPLICATION

This application claims priority to and the benefit of Korean Patent Application No. 10-2006-0102546 filed in the Korean Intellectual Property Office on Oct. 20, 2006, the entire contents of which are incorporated herein by reference.

### BACKGROUND OF THE INVENTION

1. Field of the Invention

The present invention relates to an organic light emitting diode display and a method of manufacturing the same.

2. Description of the Related Art

In recent years, among flat panel displays, organic light emitting diode (OLED) displays have attracted attention because of their low driving voltage, light weight, small size, wide viewing angle, and high speed of response. An organic light emitting diode display includes a display panel that displays images and drivers that drive the display panel.

In the display panel, thin film switching transistors are formed at the intersections of gate lines and data lines and control thin film driving transistors that are connected to driving voltage lines. At an edge of the display panel, voltage pads are formed to supply a common voltage to a common electrode and a driving voltage to the driving voltage lines.

As the size and the number of pixels in the organic light emitting diode display are increased to realize a high-resolution display, the common voltage and the driving voltage need to be increased. To supply the common voltage and the driving voltages, and to improve the uniformity of the entire substrate, a plurality of flexible printed circuits (FPCs) are connected between the voltage pads and a printed circuit board (PCB) provided separately from the drivers.

However, when a PCB is used, the thickness and the manufacturing cost of the organic light emitting diode display are increased. Further, it is difficult to form a module due to the complicated PCB structure. In addition, the plurality of FPCs that are disposed at predetermined intervals have small areas of contact with the voltage pads which increase the voltage drop in the common voltage and the driving voltage applied to the voltage pads.

### SUMMARY OF THE INVENTION

According to an aspect of the present invention, a thinner organic light emitting diode display that exhibits reduced voltage drop comprises: a display panel that includes a display region where a plurality of thin film transistors and a plurality of emission layers are formed and a peripheral area formed along the circumference of the display area; voltage pads are formed in the peripheral area for applying at least one of a driving voltage and a common voltage to the display region; an anisotropic conductive film formed on the voltage pads; and a flexible conductive film that includes contact portions each of which is formed on a corresponding portion of the anisotropic conductive film and that has a conductive layer and an insulating layer covering the conductive layer, and that has substantially the same layout as the voltage pads.

The conductive films may come into contact with the anisotropic conductive film in the contact portions.

The width of the flexible conductive film may be in a range of 1 to 10 mm.

The organic light emitting diode display may further include an external voltage source input section that applies at least one of the driving voltage and the common voltage to the voltage pads through the conductive layers.

The insulating layer may be provided with a conductive layer a portion of which is exposed to the outside.

The organic light emitting diode display may further include metal wiring lines each having one end connected to the external voltage source input section and the other end connected to the exposed portion of the conductive layer, and fixing members that fix the other ends of the metal wiring lines on the conductive layers.

The external voltage source input section may be provided in the peripheral area and is connected to a circuit board that generates the display signal.

The flexible conductive film may further include extending portions that extend to the outside of the peripheral area from the contact portions.

Each of the extending portions may extend to the outside of the peripheral area with substantially the same length as the length of the corresponding contact portion.

The flexible conductive film may further include extending portions that extend to the outside of the peripheral area from the contact portions, at least some portions of the conductive layers may be exposed to the outside in the extending portions, and the external voltage source input section may include connectors that are removably coupled with the conductive layers exposed to the outside at the extending portions.

Another exemplary embodiment of the present invention provides an organic light emitting diode display including: a display panel that includes a display area where a plurality of thin film transistors and a plurality of emission layers are formed, and a peripheral area formed along the circumference of the display area; a plurality of driving voltage pads and a plurality of common voltage pads that are alternately formed at predetermined intervals along the peripheral area of at least one side of the display area; an anisotropic conductive film that is formed on the driving voltage pads and the common voltage pads; a first flexible conductive film that is formed on the anisotropic conductive film, and that includes a plurality of first contact portions each having a first conductive layer and a first insulating layer covering the first conductive layer and having substantially the same layout as one of the driving voltage pads and the common voltage pads, and a first bent potion connecting the plurality of first bent portions and that is bent to the outside of the peripheral area; and a second flexible conductive film that is formed on the anisotropic conductive film, and that includes a plurality of second contact portions each having a second conductive layer and a second insulating layer covering the second conductive layer and having substantially the same layout as the other of the driving voltage pads and the common voltage pads.

The second flexible conductive film may further include a second bent portion that connects the plurality of second contact portions and is bent to the outside of the peripheral area.

The second flexible conductive film may further include connecting portions that linearly connect the plurality of second contact portions along the peripheral area.

The connecting portions may be disposed on the first contact portions.

The first conductive layer and the second conductive layer may come into contact with the anisotropic conductive film at the first contact portion and the second contact portion, respectively.

The width of each of the first contact portion and the second contact portion may be in a range of 1 to 10 mm.

Both surfaces of the first conductive layer may be covered with the first insulating layer at the first bent portion, and both surfaces of the second conductive layer may be covered with the second insulating layer at the second bent portion.

The organic light emitting diode display may further include an external voltage source input section that applies a driving voltage and a common voltage to the respective driving voltage pads and the respective common voltage pads through the first and second conductive layers.

In at least one of the plurality of second contact portions, the second insulating layer may be provided with a second conductive layer exposing portion that exposes a portion of the second conductive layer to the outside, and in at least one among the plurality of first contact portions, the first insulating layer may be provided with a first conductive layer exposing portion that exposes a portion of the first conductive layer to the outside.

The organic light emitting diode display may further include first metal wiring lines each having one end connected to the external voltage source input section and the other end connected to the first conductive layer through the first conductive layer exposing portion, second metal wiring lines each having one end connected to the external voltage source input section and the other end connected to the second conductive layer through the second conductive layer exposing portion, and fixing members that fix the other ends of the first and second metal wiring lines on the first and second conductive layers, respectively.

The external voltage source input section may be disposed in the peripheral area, and is connected to a circuit board that generates a display signal.

The first flexible conductive film may further include a first extending portion that extends to the outside of the peripheral area from the first bent portion, and the second flexible conductive film may further include a second extending portion that extends to the outside of the peripheral area from the second bent portion.

At least one portion of the first conductive layer may be exposed to the outside at the first extending portion, and at least one portion of the second conductive layer may be exposed to the outside at the second extending portion.

The external voltage source input section may include connectors that are removably coupled with the first and second conductive films exposed to the outside at the first and second extending portions, respectively.

Yet another exemplary embodiment of the present invention provides an organic light emitting diode display, including: a display panel that includes a display area where a plurality of thin film transistors and a plurality of emission layers are formed, and a peripheral area formed along the circumference of the display area; voltage pads that are formed in the peripheral area and that apply at least one of a driving voltage and a common voltage to the display area; an anisotropic conductive film that is formed on the voltage pads; and a flexible conductive film that is formed on the anisotropic conductive film, and that includes a conductive layer having a thickness in a range of 1 to 3000 μm and an insulating layer covering the conductive layer.

An embodiment of the present invention provided a method of manufacturing an organic light emitting diode display, including: preparing a display panel where voltage pads applying at least one of a driving voltage and a common voltage to a peripheral area along the circumference of a display area are formed; forming an anisotropic conductive film on the voltage pads; preparing a flexible conductive film including contact portions each having a conductive layer and an insulating layer covering the conductive layer and having substantially the same layout as the voltage pads so as to form the flexible conductive film on the anisotropic conductive film, such that the contact portions correspond to the respective voltage pads; and preparing an external voltage source input section applying at least one of the driving voltage and the common voltage to the voltage pads so as to connect the flexible conductive film to the external voltage source input section.

The forming of the flexible conductive film on the anisotropic conductive film may include disposing the flexible conductive film on the anisotropic conductive film such that the contact portions correspond to the respective voltage pads, and pressurizing the voltage pads and the contact portions with the anisotropic conductive film interposed therebetween such that the voltage pads and the flexible conductive film are electrically connected to each other.

The connecting of the flexible conductive film to the external voltage source input section may include forming metal wiring lines each having one end connected to the external voltage source input section and the other end connected the conductive layer of the flexible conductive film.

The flexible conductive film may further include extending portions that extend to the outside of the peripheral area from the contact portions.

The external voltage source input section may further include connectors that are removably coupled with the extending portions.

The voltage pads may include a plurality of driving voltage pads and a plurality of common voltage pads that are alternately formed at predetermined intervals along the peripheral area of at least one side of the display area, and the forming of the flexible conductive film on the anisotropic conductive film may include preparing a first flexible conductive film including a plurality of first contact portions, each having a first conductive layer and a first insulating layer covering the first conductive layer and having substantially the same layout as one of the driving voltage pads and the common voltage pads, and a first bent portion connecting the plurality of first contact portions and bent to the outside of the peripheral area so as to form the first flexible conductive film on the anisotropic conductive film, such that the first contact portions correspond to one of the driving voltage pads and the common voltage pads; and preparing a second flexible conductive film including a plurality of second contact portions, each having a second conductive layer and a second insulating layer covering the second conductive layer and having substantially the same layout as the other of the driving voltage pads and the common voltage pads, so as to form the second flexible conductive film on the anisotropic conductive film, such that the second contact portions correspond to the other of the driving voltage pads and the common voltage pads.

The connecting of the flexible conductive film to the external voltage source input section may include preparing an external voltage source input section applying a driving voltage and a common voltage to the driving voltage pads and the common voltage pads so as to connect the first flexible conductive film and the second flexible conductive film to the external voltage source input section.

The forming of the first flexible conductive film on the anisotropic conductive film may include disposing the first flexible conductive film on the anisotropic conductive film such that the first contact portion corresponds to one of the driving voltage pad and the common voltage pad, and pressurizing one of the driving voltage pad and the common voltage pad and the first contact portion with the anisotropic conductive film interposed therebetween, such that the first flexible conductive film is electrically connected to one of the driving voltage pad and the common voltage pad.

The forming of the second flexible conductive film on the anisotropic conductive film may include disposing the second flexible conductive film on the anisotropic conductive film such that the second contact portion corresponds to the other of the driving voltage pad and the common voltage pad, and pressurizing the other of the driving voltage pad and the common voltage pad and the second contact portion with the anisotropic conductive film interposed therebetween, such that the second flexible conductive film is electrically connected to one of the driving voltage pad and the common voltage pad.

The connecting of the first flexible conductive film and the second flexible conductive film to the external voltage source input section may include preparing first metal wiring lines each having one end connected to the external voltage source input section and the other end connected to the first conductive layer of the first flexible conductive film, and preparing second metal wiring lines each having one end connected to the external voltage source input section and the other end connected to the second conductive layer of the second flexible conductive film.

The second flexible conductive film may further include a second bent portion that connects the plurality of second contact portions and is bent to the outside of the peripheral area.

The second flexible conductive film may further include connecting portions that linearly connect the plurality of second contact portions along the peripheral area.

The connecting portion may be disposed on the first contact portion.

The first flexible conductive film may further include a first extending portion that extends to the outside of the peripheral area from the first bent portion, and the second flexible conductive film further includes a second extending portion that extends to the outside of the peripheral area from the second bent portion.

The external voltage source input section may further include connectors that are removably coupled with the first extending portion and the second extending portion.

### BRIEF DESCRIPTION OF THE DRAWINGS

The present invention will be described more fully hereinafter with reference to the accompanying drawings, in which:

FIG. 1 is an exploded perspective view of an organic light emitting diode display according to an exemplary embodiment of the present invention.

FIG. 2 is an equivalent circuit diagram of an organic light emitting diode display according to an exemplary embodiment of the present invention.

FIG. 3 is a plan view of a display panel of an organic light emitting diode display according to an exemplary embodiment of the present invention.

FIGS. 4 and FIG. 5 are cross-sectional views taken along the lines IV-IV and V-V in an organic light emitting diode display shown FIG. 3.

FIG. 6 is a plan view of an organic light emitting diode display according to an exemplary embodiment of the present invention.

FIG. 7 is an exploded perspective view of an organic light emitting diode display according to another exemplary embodiment of the present invention.

FIG. 8 is a cross-sectional view taken along the line VIII-VIII in an organic light emitting diode display shown in FIG. 7.

FIG. 9 is a plan view of an organic light emitting diode display shown in FIG. 7.

FIG. 10 is a plan view of a display panel of an organic light emitting diode display according to yet another exemplary embodiment of the present invention.

FIGS. 11 to 16 are cross-sectional views taken along the lines XI-XI, XII-XII, XIII-XIII, XIV-XIV, XV-XV, and XVI-XVI in an organic light emitting diode display shown in FIG. 10.

FIGS. 17 to 21 are plan views of a display panel in an intermediate stage of a method of manufacturing an organic light emitting diode display according to the exemplary embodiment shown in FIG. 10.

FIG. 22 is a plan view of a display panel of an organic light emitting diode display according to still another exemplary embodiment of the present invention.

FIGS. 23 to 26 are cross-sectional views taken along the lines XXIII-XXIII, XXIV-XXIV, XXV-XXV, and XXVI-XXVI in an organic light emitting diode display shown in FIG. 22.

FIG. 27 is a plan view of a display panel of an organic light emitting diode display according to a further exemplary embodiment of the present invention.

FIG. 28 is a cross-sectional view taken along the line XXVIII-XXVIII in an organic light emitting diode display shown in FIG. 27.

FIG. 29 is a plan view of a display panel of an organic light emitting diode display according to a further exemplary embodiment of the present invention.

### DETAILED DESCRIPTION OF THE EMBODIMENTS

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

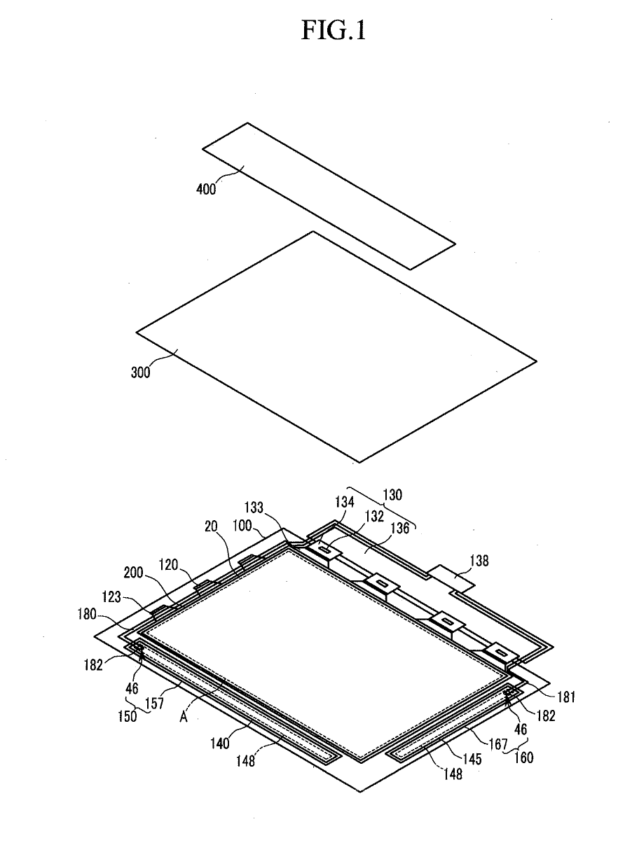

First, an organic light emitting display according to an exemplary embodiment of the present invention will be described in detail with reference to FIGS. 1 to 6.

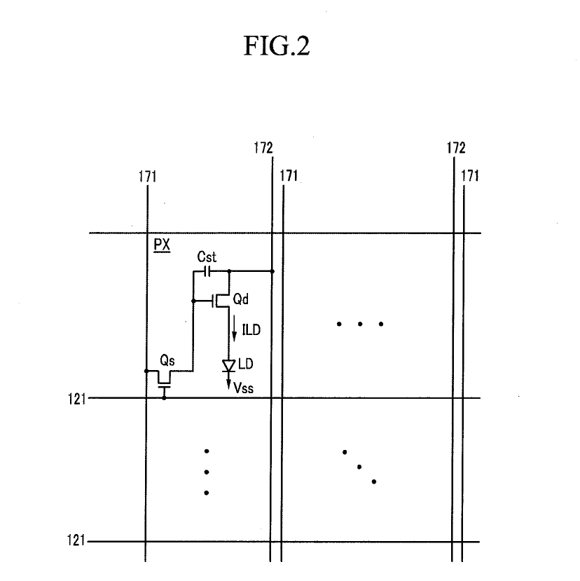

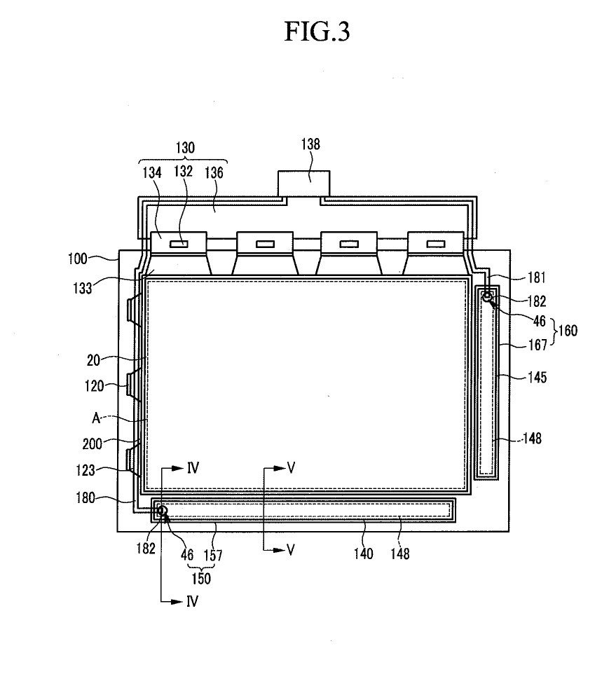

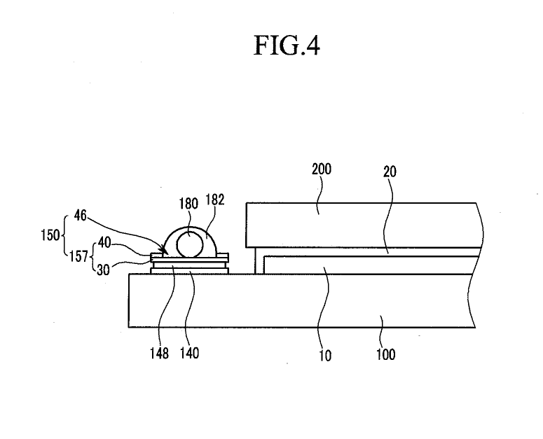

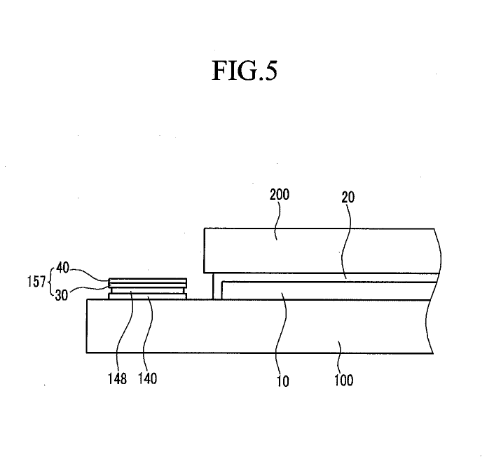

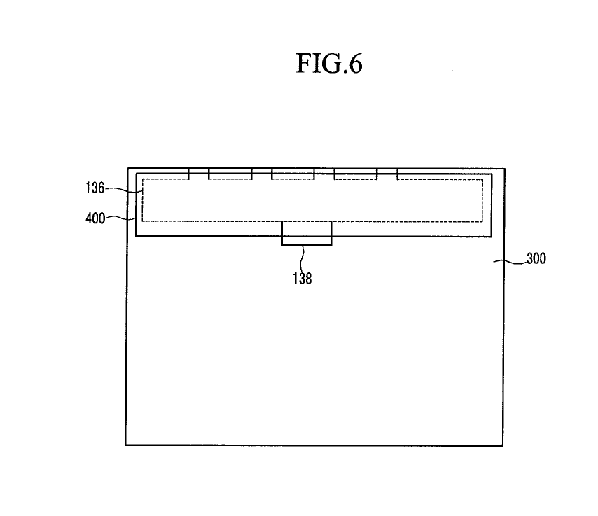

FIG. 1 is an exploded perspective view of an organic light emitting diode display according to an exemplary embodiment of the present invention, FIG. 2 is an equivalent circuit diagram of an organic light emitting diode display according to an exemplary embodiment of the present invention, FIG. 3 is a plan view of a display panel of an organic light emitting diode display according to an exemplary embodiment of the present invention, FIGS. 4 and FIG. 5 are cross-sectional views taken along the lines IV-IV and V-V in an organic light emitting diode display shown FIG. 3, and FIG. 6 is a plan view of an organic light emitting diode display according to an exemplary embodiment of the present invention.

An organic light emitting diode display according to an exemplary embodiment of the present invention includes a display panel 100, a sealing substrate that serves as a sealing member 200 to cover a display area A of the display panel 100, and a panel cover 300 that protects and supports the display panel 100. Further, the organic light emitting diode display further includes a circuit board cover 400 that protects a circuit board 136 when the circuit board 136 is located at the upper side of the panel cover 300.

The display panel 100 includes the display area A that displays images and a peripheral area outside the display area A.

As shown in FIG. 2, in the display area A, a plurality of signal lines 121, 171, and 172, and a plurality of pixels are formed. The plurality of pixels are connected to the plurality of signal lines 121, 171, and 172 and are disposed substantially in a matrix.

The signal lines include a plurality of gate lines 121 that transmit gate signals or scanning signals, a plurality of data lines 171 that transmit data signals, and a plurality of driving voltage lines 172 that transmit a driving voltage. The gate lines 121 extend in a row direction and are disposed in parallel to one another, and the data lines 171 and the driving voltage lines 172 extend in a column direction and are disposed in parallel to each other.

The pixels PX each include a switching transistor Qs, a driving transistor Qd, a storage capacitor Cst, and an organic light emitting diode (OLED) LD.

The switching transistor Qs includes a control terminal, an input terminal, and an output terminal. The control terminal is connected to the gate line 121, the input terminal is connected to the data line 171, and the output terminal is connected to the driving transistor Qd. The switching transistor Qs transmits a data signal applied to the data line 171 to the driving transistor Qd in response to a scanning signal that is applied to the gate line 121.

Also, the driving transistor Qd has a control terminal, an input terminal, and an output terminal. The control terminal is connected to the switching transistor Qs, the input terminal is connected to the driving voltage line 172, and the output terminal is connected to the organic light emitting diode LD. The driving transistor Qd provides an output current ILD whose magnitude is changed according to the voltage between the control terminal and the output terminal.

The capacitor Cst is connected between the control terminal and the input terminal of the driving transistor Qd. The capacitor Cst charges a data signal that is applied to the control terminal of the driving transistor Qd, and maintains the data signal even after the switching transistor Qs is turned off.

The organic light emitting diode LD has an anode that is connected to the output terminal of the driving transistor Qd, and a cathode that is connected to a terminal of a common voltage Vss. The organic light emitting diode LD emits light such that the intensity of the light is changed according to the output current ILD of the driving transistor Qd, and displays images.

Each of the switching transistor Qs and the driving transistor Qd is composed of an n-channel field effect transistor (FET). However, at least one of the switching transistor Qs and the driving transistor Qd may be composed of a p-channel field effect transistor. Further, the connection relationships among the transistors Qs and Qd, the capacitor Cst, and the organic light emitting diode LD may be changed.

In the peripheral area of the display, a driving voltage pad 140 is connected to one end of the driving voltage lines 172 and a common voltage pad 145 is electrically connected to one end of a common electrode 20.

The driving voltage pad 140 is formed to have an elongated rectangular shape along the peripheral area opposite to the data driver 132, with the display area A interposed therebetween. The driving voltage pad 140 applies, to the driving voltage line 172, a driving voltage of a predetermined level that is applied from an external voltage source input section 138 through a first metal wiring line 180.

The common voltage pad 145 is formed to have an elongated rectangular shape along the peripheral area opposite to the gate driver 120 with the display area A interposed therebetween. The common voltage pad 145 applies, to the common electrode 20, the predetermined level of the common voltage from the external voltage source input section 138 through a second metal wiring line 181. In FIGS. 1 and 3, the common electrode 20 and the common voltage pad 145 are shown to be separated from each other. However, the common electrode 20 and the common voltage pad 145 may be directly connected to each other, and may be connected to each other through a bridge electrode made of indium tin oxide (ITO).

The driving voltage pad 140 and the common voltage pad 145 may be made of a wiring line forming material, such as a gate metal material, they may include an arbitrary metal layer that is made of a metal material having conductivity, or they may be made of ITO or indium zinc oxide (IZO).

The locations of the driving voltage pad 140 and the common voltage pad 145 may be changed with each other, and they may be changed within the peripheral area if necessary.

On the driving voltage pad 140 and the common voltage pad 145, anisotropic conductive films 148 are formed in substantially the same layout as the driving voltage pad 140 and the common voltage pad 145, respectively. Further, flexible conductive films 150 and 160 are formed on the anisotropic conductive films 148 in substantially the same layout as the driving voltage pad 140 and the common voltage pad 145, respectively.

The voltage pads 140 and 145, the anisotropic conductive films 148 that correspond to the respective voltage pads 140 and 145, and the flexible conductive films 150 and 160 that correspond to the respective voltage pads 140 and 145 have substantially the same layout, but in FIG. 1 and FIGS. 3 to 5, they are shown to have different lengths and widths from one another for convenience of display. However, since the voltage pads 140 and 145, the anisotropic conductive films 148 that correspond to the respective voltage pads 140 and 145, and the flexible conductive films 150 and 160 that correspond to the respective voltage pads 140 and 145 have substantially the same layout, they may have slightly different lengths and widths from one another.

The anisotropic conductive film 148 includes an epoxy resin layer that has excellent insulating properties and adhesiveness, and conductive particles (not shown) that are dispersed therein. The conductive particles (not shown) of the anisotropic conductive film 148 that are located between the driving voltage pad 140 and the first flexible conductive film 150 contact the driving voltage pad 140 and the conductive layer 30 of the first flexible conductive film 150. Accordingly, the driving voltage pad 140 and the first flexible conductive film 150 are electrically connected to each other.

The conductive particles (not shown) of the anisotropic conductive film 148 that is located between the common voltage pad 145 and the second flexible conductive film 160 also contacts the common voltage pad 145 and the conductive layer 30 of the second flexible conductive film 160. Accordingly, the common voltage pad 145 and the second flexible conductive film 160 are electrically connected to each other.

In the process of connecting the voltage pads 140 and 145 and the flexible conductive films 150 and 160, the anisotropic conductive films 148 and the flexible conductive films 150 and 160 are sequentially laminated on the respective voltage pads 140 and 145. A pressing process is performed that pressurizes the flexible conductive films 150 and 160. In this way, the connecting process is performed. Through these processes, the respective voltage pads 140 and 145 and the flexible conductive films 150 and 160 contact the conductive particles (not shown) of the pressurized anisotropic conductive films 148, and thus they are physically and electrically connected to each other through the conductive particles.

The flexible conductive films 150 and 160 each include a conductive layer 30 that is a thin film formed in an elongated rectangular shape along the peripheral area of one side, and an insulating layer 40 that covers the conductive layer 30.

In the present exemplary embodiment, the flexible conductive films 150 and 160 have substantially the same layout as the respective corresponding voltage pads 140 and 145, and are electrically connected to the respective voltage pads 140 and 145. Accordingly, in the present exemplary embodiment, the flexible conductive films 150 and 160 include respective contact portions 157 and 167, each of which includes the conductive layer 30 that comes into direct contact with the anisotropic conductive film 148 and the insulating layer 40 that covers a top surface of the conductive layer 30.

The width of each of the contact portions 157 and 167 is not limited to a specific value. However, the width of each of the contact portions 157 an 167 is preferable in a range of about 1 to 10 mm when considering the size of the display area A, the contact resistance, the width of the peripheral area of the organic light emitting diode display, and the width of the voltage pads 140 and 145, and is more preferable in a range of about 2 to 3 mm.

However, different from the present exemplary embodiment, the flexible conductive films 150 and 160 may include, in addition to the contact portions 157 and 167, the conductive layers 30, and the insulating layers 40 that cover a top surface and a bottom surface of the conductive layers 30, extending portions that protrudes toward the outside of the peripheral area from the contact portions 157 and 167 such that they have substantially the same lengths as the contact portions 157 and 167. In this case, the total width of the flexible conductive films 150 and 160 is larger by the extending portions than that of the present exemplary embodiment. As a result, they can easily come into contact with the anisotropic conductive films 148, and electrical resistance can be further reduced in the flexible conductive films 150 and 160.

The conductive layer 30 is made of a conductive metal that has excellent electric conductivity and thus has low resistance, and may contain at least one of aluminum, silver, and copper.

The thickness of the conductive layer 30 is not limited to a specific value, but is preferable in a range of about 1 to 3000 μm, when properly considering a thickness of an organic light emitting diode display when the thickness of the conductive layer 30 is larger than a diameter of a minute wiring line according to the related art as a conductor covered with the insulating layer 40 to decrease electrical resistance in the conductive layer 30.

Forming the conductor covered with the insulating layer 40 of the conductive layer 30 that is a rectangular thin film having substantially the same layout as the respective voltage pads 140 and 145, increases the contact cross-sections between the voltage pads 140 and 145 and the flexible conductive films 150 and 160 having the anisotropic conductive films 148 interposed therebetween. Thus, the electrical resistance is reduced, unlike the minute wiring lines of the prior art. Accordingly, it is possible to reduce the voltage drop of the common voltage or the driving voltage that is applied from the external voltage source input section 138 to the respective voltage pads 140 and 145.

The insulating layer 40 is made of a flexible insulating resin.

Portions of the insulating layers 40 are respectively removed at the contact portion 157 of the first flexible conductive film 150 at the left side and at a portion of the second flexible conductive film 150 at an upper side, thereby opening portions 46 in the conductive layer that expose portions of the conductive layers 30 to the outside.

One end of the first metal wiring line 180 that is fixed by a fixing member 182 is connected to the conductive layer 30 of the first flexible conductive film 150 through the conductive layer exposed portion 46 that is formed in the first flexible conductive film 150. Further, one end of the second metal wiring line 181 that is fixed by the fixing member 182 is connected to the conductive layer 30 of the second flexible conductive film 160 through the exposed portion 46 that is formed in the second flexible conductive film 160.

The fixing members 182 may each be lead solder having excellent conductivity to improve electrical contact characteristics between the first and second metal wiring lines 180 and 181 and the conductive layer 30.

Alternatively to the lead solder, a known cured conductive resin may be used.

The gate driver 120 is mounted in the peripheral area that is opposite to the peripheral area where the common voltage pad 145 is formed. Further, a main driver 130 that generates driving signals including gate signals and data signals is mounted in the peripheral area that is opposite to the peripheral area where the driving voltage pad 140 is formed.

The gate driver 120 transmits a gate signal received from the circuit board 136 of the main driver 130 to the gate line 121. The gate driver 120 is mounted on the display panel 100 as a chip on glass (COG) type. In the case where the gate driver 120 is mounted on the display panel 100 as a COG type, a gate on/off voltage that is output from the circuit board 136 may be provided to the gate driver 120 through the minute wiring line patterns (not shown) that are formed on the data driver 132 and the display panel 100. That is, the organic light emitting diode display according to the exemplary embodiment of the present invention does not include a separate circuit board that is connected to the gate driver 120.

The gate driver 120 may not be a chip, and may include a shift register that is connected to an end of the gate line 121. The shift register includes a plurality of thin film transistors that are formed on the display panel 100, and is directly formed on the display panel 100 when signal wiring lines are formed. Even when the gate driver 120 is composed of the shift register, the gate on/off voltage applied to the gate line 121 and various display signals are directly transmitted to the shift register through the electrical wiring lines, which does not need a separate circuit board.

In contrast, the gate driver 120 may be supplied with the gate on/off voltage and the various display signals through a separate circuit board (not shown) that is provided in the vicinity of the gate driver 120.

The main driver 130 includes data drivers 132, flexible members 134, and the circuit board 136.

The data driver 132 is formed on the flexible member 134, and applies a data signal received from the circuit board 136 to the data line 171.

The flexible member 134 physically and electrically connects the circuit board 136 and the display panel 100. The flexible member 134 may be attached to the display panel 100 and the circuit board 136 by using the anisotropic conductive film (not shown). Since the flexible member 134 has a flexible property, it may be easily deformed. Although not shown, minute wiring line patterns are formed in the flexible member 134 so as to electrically connect the data driver 132 to the display panel 100 and the circuit board 136.

The circuit board 136 is connected to the data driver 132 through the flexible member 134, and includes a voltage generator that generates various voltages, such as a gate voltage, a data voltage, and the like, which are supplied to the display area A, and a timing controller that outputs various display signals supplied to the gate driver 120 and the data driver 132.

According to another exemplary embodiment of the present invention, a plurality of circuit boards 136 may be provided in a state where they are separated into portions generating a gray voltage and portions receiving display signals. That is, the plurality of circuit boards 136 that are connected to the data drivers 132 may be provided and connected to one another. An external voltage source, and an external voltage source input unit 138 that receives image signals, are coupled with the circuit board 136.

In the display panel 100 according to the present exemplary embodiment, light emitted from an emission layer 10 exits from a back surface of the display panel 100, and thus images are displayed on the display panel 100. Accordingly, as shown in FIG. 6, after the display panel 100 is completed, the circuit board 136 is folded into a surface opposite to a surface of the display panel 100 from which light exits and on which the images are displayed. That is, the circuit board 136 that is connected to the data driver 132 is bent into the front surface of the display panel 100 that emits light through the back surface thereof, and is located at the upper side of the panel cover 300.

The gate line 121 and the data line 171 in the display area A extend to the peripheral area, and are connected to the gate driver 120 and the data driver 132, respectively. At the connection portions between the gate line 121 and the data line 171 and the gate driver 120 and the data driver 132, a gate fan-out portion 123 where the wiring line interval of the extending gate line 121 gradually decreases, and a data fan-out portion 133 where the wiring line interval of the data line 171 gradually decreases are formed, respectively.

The sealing substrate that serves as the sealing member 200 is bonded to the upper side of the front surface of the display panel 100.

After the sealing substrate that serves as the sealing member 200 is aligned so as to correspond to the display area A of the display panel 100, the sealing substrate is bonded to the display panel 100. The thickness of the sealing substrate that serves as the sealing member 200 is not limited to a specific value, but the sealing substrate generally has a thickness in a range of about 0.5 to 1.0 mm. The sealing substrate that serves as the sealing member 200 prevents moisture or oxygen from permeating into the emission layer 10 formed in the display area A, and prevents degradation of the emission layer 10. A blocking layer and/or a protective layer that is made of an organic material and/or an inorganic material may be formed between the common electrode 20 formed on the uppermost side of the display area A of the display panel 100 and the sealing substrate serving as the sealing member 200. The blocking layer and/or the protective layer is generally made of a material that is cured by heat or light, which enables the display panel 100 and the sealing substrate serving as the sealing member 200 to be easily bonded to each other.

Different from the present exemplary embodiment, the sealing member 200 may be formed of a sealing resin instead of the sealing substrate.

The first metal wiring line 180, which is disposed from the circuit board 136 to the left peripheral area and the left side end of the lower peripheral area along the side of the sealing substrate serving as the sealing member 200, applies a driving voltage supplied from the external voltage source input unit 138 to the driving voltage pad 140. Further, the second metal wiring line 181, which is disposed from the circuit board 136 to the upper end of the right peripheral area along the side of the sealing substrate serving as the sealing member 200, applies the common voltage to the common voltage pad 145. Although not shown in the drawings, the metal wiring lines 180 and 181 may be surrounded by insulating cloth.

The specific coupling between the metal wiring lines 180 and 181 and the voltage pads 140 and 145 corresponding to the respective metal wiring lines 180 and 181 will now be described.

The first metal wiring line 180 has one end that is connected to the external voltage source input section 138, and the other end is fixedly connected to the conductive layer 30 exposed through the conductive layer exposing portion 46 of the first flexible conductive film 150 formed in a lower peripheral area of the display panel 100 by means of the fixing member 182. Since the conductive layer 30 of the first flexible conductive film 150 is connected to the driving voltage pad 140 through the anisotropic conductive film 148, the first metal wiring line 180 is electrically and physically connected to the driving voltage pad 140.

Further, the second metal wiring line 181 has one end that is connected to the external voltage source input section 138, and the other end is connected to the conductive layer 30 exposed through the conductive layer exposing portion 46 of the second flexible conductive film 160 formed in the right peripheral area of the display panel 100 by means of the fixing member 182. Since the conductive layer 30 of the second flexible conductive film 160 is connected to the common voltage pad 145 through the anisotropic conductive film 148, the second metal wiring line 181 is electrically and physically connected to the common voltage pad 145.

The metal wiring lines 180 and 181 contain copper, aluminum, or silver that have excellent electrical conductivity, or an alloy thereof. The diameter of each of the metal wiring lines 180 and 181 is not limited to a specific value, but is preferable in a range of about 0.05 to 0.5 mm so as to not protrude to the upper side of the sealing member 200, when considering that the sealing substrate serving as the sealing member 200 has a thickness in a range of about 0.5 to 1.0 mm, while reducing a voltage drop due to the increase in resistance.

When the metal wiring lines 180 and 181 are surrounded by the insulating cloth (not shown), the insulating cloth is removed at portions of the metal wiring lines 180 and 181 that are coupled with the conductive layers 30 of the flexible conductive films 150 and 160 due to the conductive fixing members 182.

The panel cover 300 is formed on the sealing substrate that serves as the sealing member 200.

After the sealing substrate serving as the sealing member 200 is bonded to the display panel 100, the circuit board 136 is connected thereto, and the metal wiring lines 180 and 181 are fixedly arranged along the peripheral area, the panel cover 300 is formed on the sealing substrate that serves as the sealing member 200. The panel cover 300 wraps the display panel 100 such that it can be easily transported, and supports the display panel 100 so as to protect the display panel 100. The panel cover 300 is made of an insulating material such that it is not electrically connected to the plurality of signal wiring lines and the voltage pads 140 and 145 that are formed on the display panel 100. The panel cover 300 may contain an insulating resin that has excellent strength while being light.

Different from the present exemplary embodiment, the external voltage source input section 138 that inputs the driving voltage and the common voltage corresponding to the respective voltage pads 140 and 145 may not be coupled with the circuit board 136, and may be provided on the panel cover 300. In this case, the metal wiring lines 180 and 181 may be directly connected to the external voltage source input section 138 disposed on the panel cover 300 in the peripheral area because they do not need to be disposed to extend from the peripheral area to the circuit board 136.

The external voltage source input section 138 applies the driving voltage and the common voltage each having a predetermined level generated by the external voltage source (not shown) to the driving voltage pad 140 and the common voltage pad 145 that are electrically connected to the flexible conductive films 150 and 160 and the anisotropic conductive films 148 through the corresponding respective metal wiring lines 180 and 181.

The circuit board cover 400 is disposed on the panel cover 300, and protects the circuit board 136 that is exposed to the outside. The circuit board cover 400 is generally formed in a shape of a thin plate made of an insulating resin material, and is fixed on the panel cover 300 by means of a screw or a predetermined coupling portion (not shown).

According to the related art, the common voltage and the driving voltage that are input by the external voltage source input unit 138 are applied to the corresponding respective voltage pads 140 and 145 through a plurality of printed circuit boards (PCBs) and FPCs. Accordingly, since the structure of the side of the display panel 100 becomes complicated due to the plurality of PCBs, the thickness of the organic light emitting diode display is increased, and it is difficult to form a module. Further, the FPCs that are attached to the respective voltage pads 140 and 145 at predetermined intervals come into contact with the voltage pads 140 and 145 in small areas, and thus resistance is increased, which increases a voltage drop.

However, the organic light emitting diode display according to the exemplary embodiment of the present invention has a simple structure that includes the circuit boards that are input with the driving voltage and the common voltage corresponding to the voltage pads 140 and 145 from the external voltage source input unit 138, the flexible conductive films 150 and 160 that have substantially the same layout as the voltage pads 140 and 145 instead of the plurality of PCBs and FPCs with a complicated structure, and the metal wiring lines 180 and 181 that apply the voltage to the flexible conductive films 150 and 160. Accordingly, the structure of the peripheral area of the display panel 100 can be simplified while stably supplying the driving voltage and the common voltage. As a result, the thickness of the organic light emitting diode display can be reduced, a module can be easily formed, and the voltage drop can be reduced.

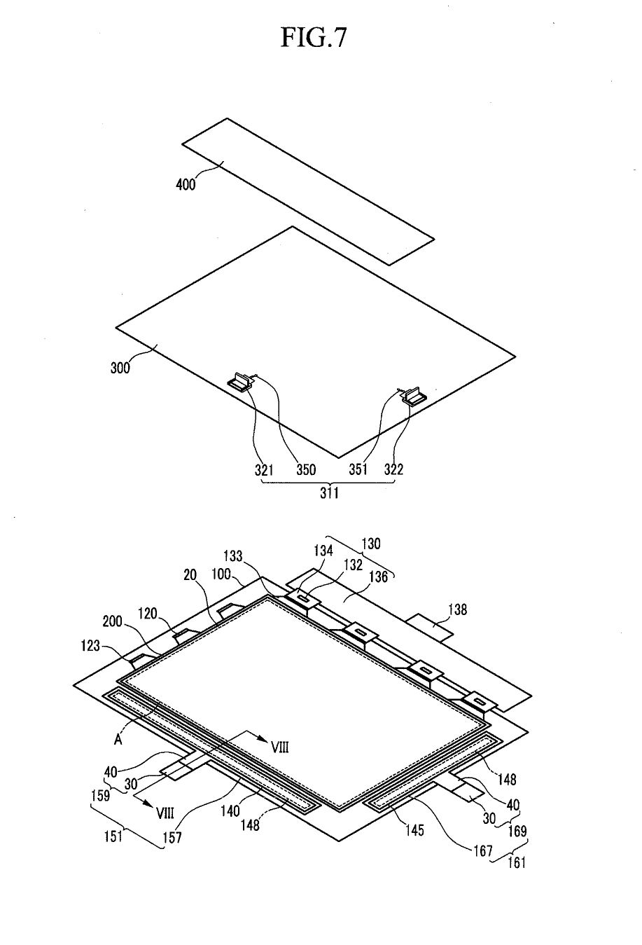

An organic light emitting diode display according to another exemplary embodiment of the present invention will be described with reference to FIGS. 7 to 9. At this time, the differences between the organic light emitting diode display according to this exemplary embodiment of the present invention and the organic light emitting diode display shown in FIG. 1 will be mainly described.

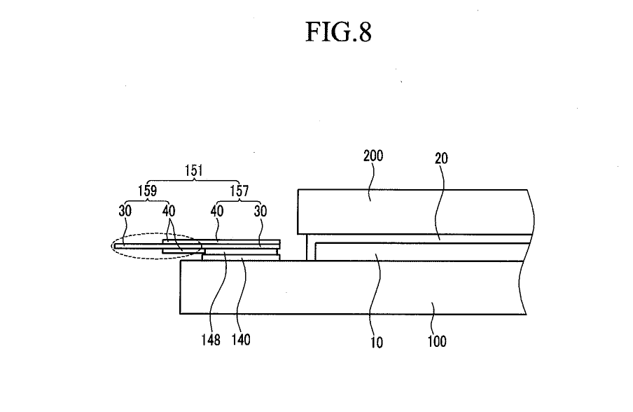

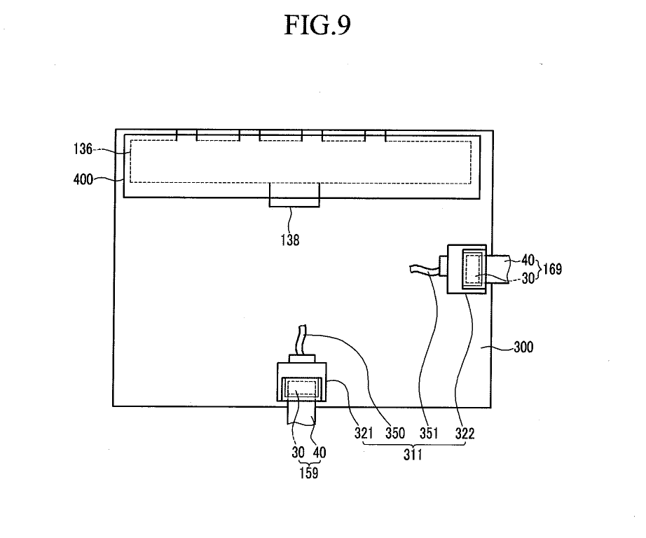

FIG. 7 is an exploded perspective view of an organic light emitting diode display according to another exemplary embodiment of the present invention, FIG. 8 is a cross-sectional view taken along the line VIII-VIII in the organic light emitting diode display shown in FIG. 7, and FIG. 9 is a plan view of an organic light emitting diode display shown in FIG. 7.

Different from the organic light emitting diode display shown in FIG. 1, the organic light emitting diode display shown in FIGS. 7 to 9 further includes the contact portions 157 and 167 that have the substantially same layout as the voltage pads 140 and 145 to which the respective flexible conductive films 151 and 161 correspond to, and extending portions 159 and 169 that extend to the outside of the peripheral area from the respective contact portions 157 and 167. Further, in addition to the external voltage source input unit 138, a separate external voltage source input unit 311, which is directly connected to the respective exposed conductive layers 30 of the extending portions 159 and 169 without using the metal wiring lines 180 and 181, is attached to the panel cover 300.

As shown in FIG. 8, at portions of the extending portions 159 and 169 corresponding to the dotted line regions that are connected to the respective contact portions 157 and 167, a top surface and a bottom surface of the conductive layer 30 are covered with the insulating layers 40. However, at the ends of the extending portions 159 and 169 that are coupled with connectors 321 and 322, the insulating layers 40 are removed, and the conductive layers 30 are exposed to the outside. Accordingly, the respective exposed conductive layers 30 are removably coupled with the connectors 321 and 322 of the external voltage source input section 311.

The widths and lengths of the extending portions 159 and 169, and the coupling positions between the extending portions 159 and 169 and the contact portions 157 and 167, may be changed in various ways, if necessary.

The separate external voltage source input section 311 includes the connectors 321 and 322 that are respectively connected to the conductive layers 30 exposed at the extending portions 159 and 169.

The driving voltage and the common voltage each having a predetermined level that are generated by the external voltage source (not shown) are applied to the respective conductive layers 30 that are connected to the connectors 321 and 322 of the external voltage source input unit 311 through respective external voltage cables 351 and 352. Accordingly, the driving voltage and the common voltage are applied to the driving voltage pad 140 and the common voltage pad 145 that are electrically connected to the contact portions 157 and 167 of the flexible conductive films 151 and 161 and the anisotropic conductive films 148.

Meanwhile, different from the present exemplary embodiment, the external voltage cables 351 and 352 may not be included, and the external voltage source (not shown) and the connectors 321 and 322 of the external voltage source input section 311 may be directly connected to each other.

The organic light emitting diode display according to the exemplary embodiment shown in FIGS. 7 to 9 includes the contact portions 157 and 167 that have the same layout as the voltage pads 140 and 145, and the flexible conductive films 151 and 161 that include the extending portions 159 and 169 directly connected to the separate external voltage source input section 311. Accordingly, the structure of the peripheral area of the display panel 100 can be simplified while stably supplying the driving voltage and the common voltage. As a result, the thickness of the organic light emitting diode display can be reduced, a module can be easily formed, and the voltage drop can be reduced.

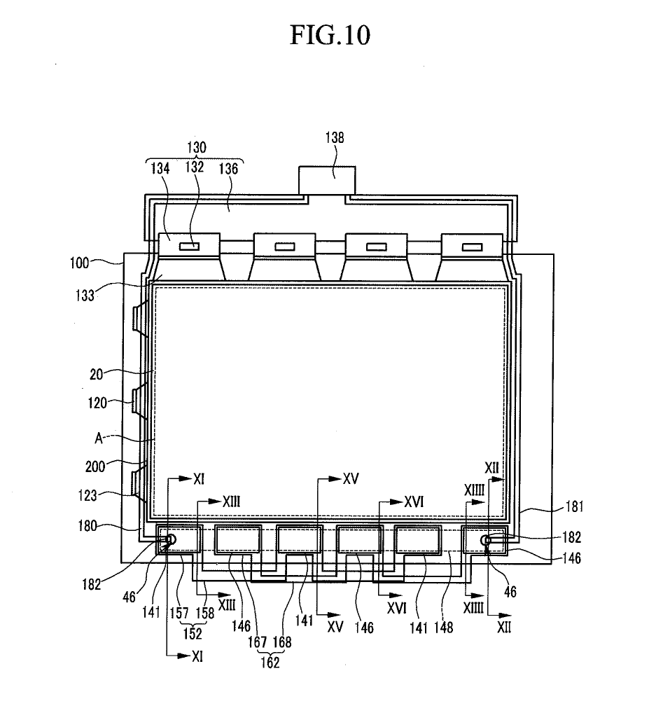

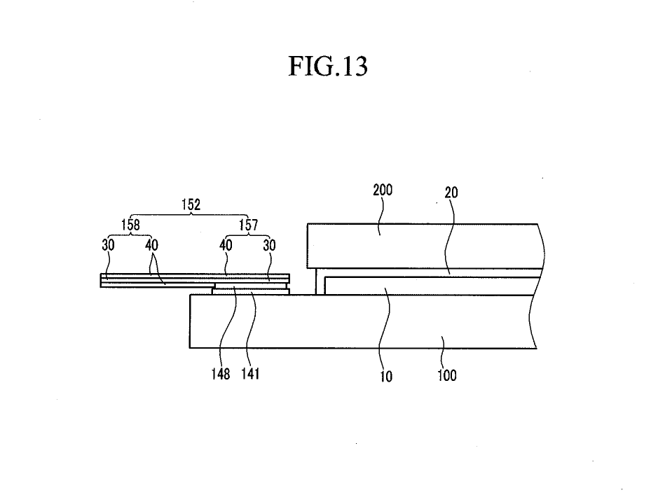

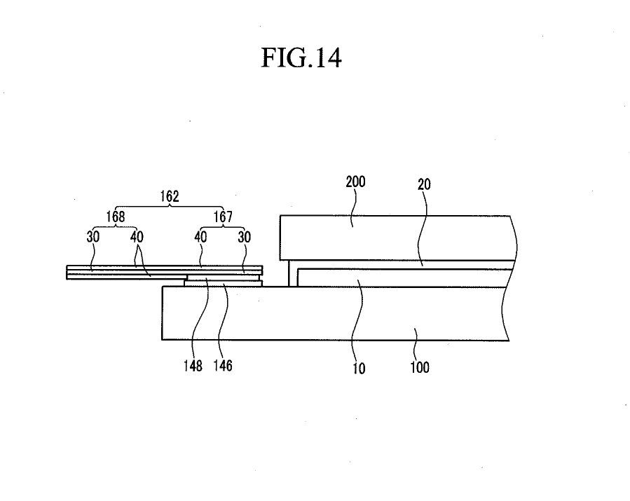

Hereinafter, an organic light emitting diode display according to yet another exemplary embodiment of the present invention will be described with reference to FIGS. 10 to 16. However, only the differences between the organic light emitting diode display according to this exemplary embodiment of the present invention and the organic light emitting diode display according to the exemplary embodiment shown in FIG. 1 will be mainly described.

In the organic light emitting diode display according to FIGS. 10 to 16, a plurality of driving voltage pads 141 and a plurality of common voltage pads 146 are alternately formed at predetermined intervals in the peripheral area opposite to the main driver 130 with the display area interposed therebetween.

Further, the anisotropic conductive film 148 is formed on the plurality of driving voltage pads 141 and the plurality of common voltage pads 146, and between the plurality of driving voltage pads 141 and the plurality of common voltage pads 146. However, different from the present exemplary embodiment, the anisotropic conductive film 148 may not be formed between the plurality of driving voltage pads 141 and the plurality of common voltage pads 146.

The contact portion 157 of a first flexible conductive film 152 is formed on the anisotropic conductive film 148 on each driving voltage pad 141, and the contact portion 167 of a second flexible conductive film 162 is formed on the anisotropic conductive film 148 on the common voltage pad 146.

The neighboring contact portions 157 of the first flexible conductive film 152 are connected to each other by bent portions 158, and the neighboring contact portions 167 of the second flexible conductive film 162 are connected to each other by bent portions 168.

Each of the contact portions 157 and 167 includes the conductive layer 30 that comes into direct contact with the anisotropic conductive film 148, and the insulating layer 40 that covers the top surface of the conductive layer 30.

Further, the bent portions 158 and 168 connect the corresponding contact portions 157 and 167, and are bent to extend to the outside of the peripheral area. The bent portions 158 and 168 each include the conductive layer 30 and the insulating layer 40 that covers both surfaces of the conductive layer 30.

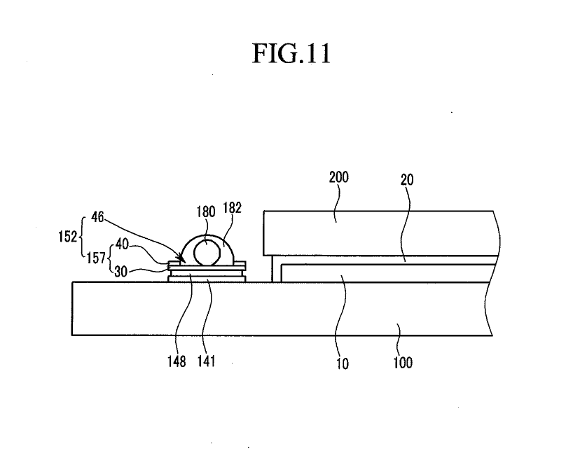

As shown in FIGS. 10 and 11, in the contact portion 157 of the first flexible conductive film 152 that is located at the leftmost side, a portion of the insulating layer 40 is removed, which forms a conductive layer exposing portion 46 that exposes the conductive layer 30 below the insulating layer 40. The other end of the first metal wiring line 180 that has one end connected to the external voltage source input section 138 is fixedly connected to the conductive layer 30 exposed through the conductive layer exposing portion 46 by means of the fixing member 182.

Since the conductive layer 30 of the contact portion 157 of the first flexible conductive film 152 is connected to the driving voltage pad 141 through the anisotropic conductive film 148, the first metal wiring line 180 is physically and electrically connected to the driving voltage pad 140.

The width of each of the contact portions 157 and 167 is preferable in a range of about 1 to 10 mm, and more preferable in a range of about 2 to 3 mm, as described for the organic light emitting diode display shown in FIG. 1.

The length of each of the bent portions 158 and 168 in a direction that corresponds to the width-wise direction of the contact portions 157 and 167 is not limited to a specific value. However, the length of each of the bent portions 158 and 168 should preferably lie in the range of about 1 to 10 mm and more preferably in the range of about 2 to 5 mm, when considering the contact resistance and the thickness of the organic light emitting diode display.

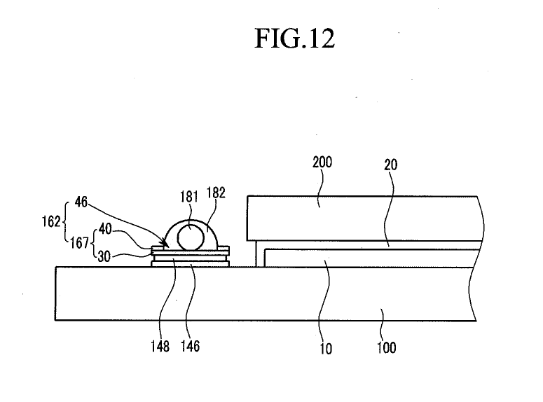

As shown in FIGS. 10 and 12, a portion of the insulating layer 40 is removed even at the contact portion 167 of the second flexible conductive film 162 that is located at the rightmost side, which forms a conductive layer exposing portion 46 that exposes the conductive layer 30 below the insulating layer 40. The other end of the second metal wiring line 181 that has one end connected to the external voltage source input section 138 is fixedly connected to the conductive layer 30 exposed through the conductive layer exposing portion 46 by means of the fixing member 182.

Accordingly, since the conductive layer 30 of the contact portion 167 of the second flexible conductive film 162 is connected to the common voltage pad 146 through the anisotropic conductive film 148, the second metal wiring line 181 is physically and electrically connected to the common voltage pad 146.

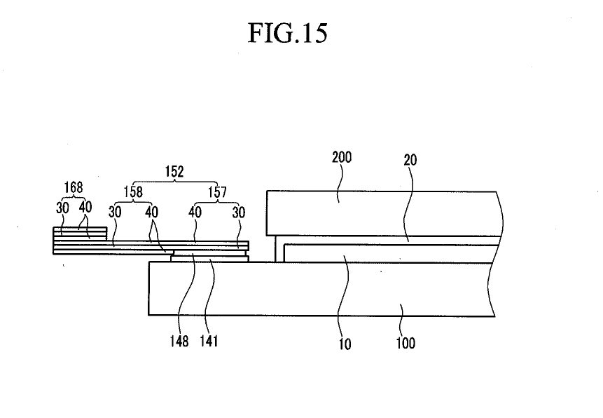

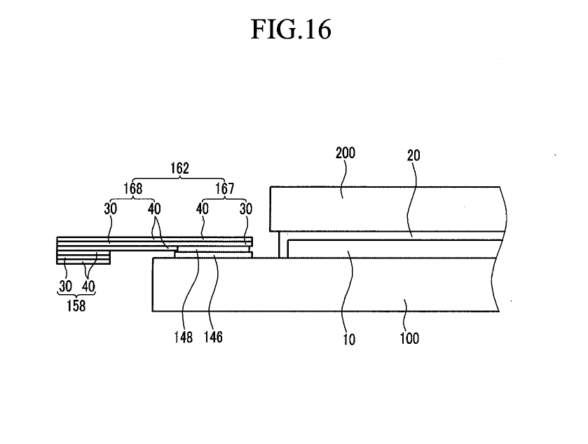

As shown in FIGS. 15 and 16, in the organic light emitting diode display according to the present exemplary embodiment, the bent portion 168 of the second flexible conductive film 162 is laminated on the bent portion 158 of the first flexible conductive film 152. This is because the first flexible conductive film 152 is connected to the driving voltage pad 141, and the second flexible conductive film 162 is then connected to the common voltage pad 146. However, different from the present exemplary embodiment, the first flexible conductive film 152 may be connected to the driving voltage pad 141 after the second flexible conductive film 162 is connected to the common voltage pad 146. Accordingly, the bent portion 158 of the first flexible conductive film 152 may be laminated on the bent portion 168 of the second flexible conductive film 162. 1

If using the organic light emitting diode display according to the exemplary embodiment of the present invention shown in FIGS. 10 to 16, it is possible to achieve the same effect as that of the organic light emitting diode display according to the exemplary embodiment of the present invention shown in FIG. 1.

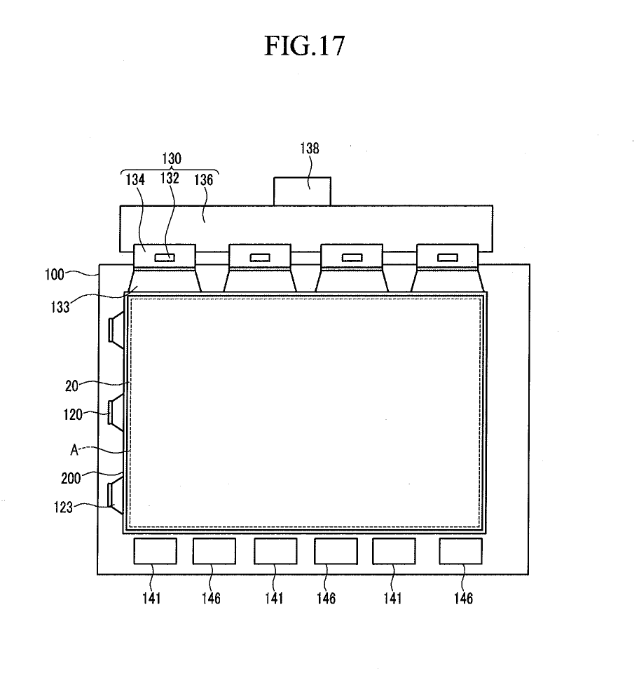

Hereinafter, a method of manufacturing the organic light emitting diode display according to the exemplary embodiment of the present invention shown in FIGS. 10 to 16 will be described with reference to FIGS. 17 to 21.

FIGS. 17 to 21 are plan views of a display panel in an intermediate stage of the method of manufacturing the organic light emitting diode display according to the exemplary embodiment of the present invention shown in FIG. 10.

First, as shown in FIG. 17, by using a known method, the plurality of driving voltage pads 141 and the plurality of common voltage pads 146 are alternately formed at predetermined intervals along the peripheral area of at least one side of the display area A, and the display panel 100 is prepared where a sealing substrate serving as the sealing member 200 is formed to cover the display area A.

According to the present exemplary embodiment, the plurality of driving voltage pads 141 and the plurality of common voltage pads 146 are formed in a peripheral area opposite to the peripheral area where the main driver 130 is mounted. However, they may be formed in a peripheral area opposite to the peripheral area where the gate driver 120 is formed.

Meanwhile, in the step of preparing the display panel 100, the gate driver 120 is formed in the left peripheral area of the display area A by using a known method, and the main driver 130 including the data driver 132 is also formed in the upper peripheral area.

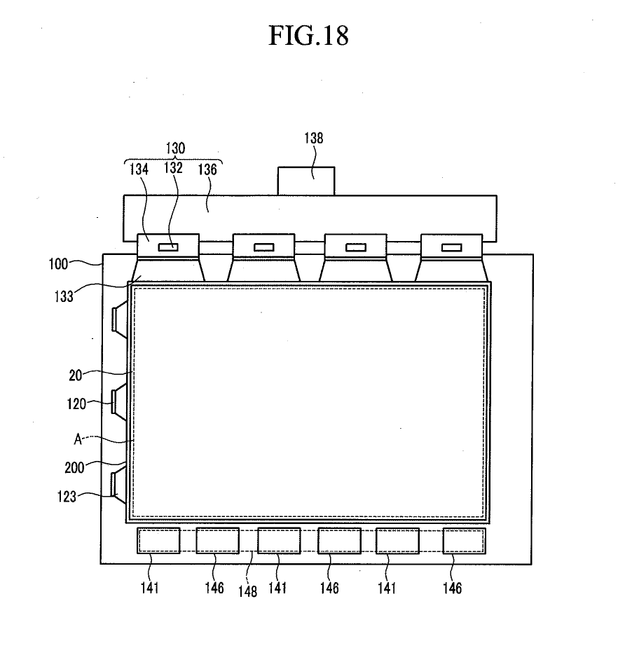

Then, as shown in FIG. 18, the anisotropic conductive film 148 is formed on the voltage pads 141 and 146.

The anisotropic conductive film 148 is formed on the voltage pads 141 and 146 and between the voltage pads 141 and 146. However, the anisotropic conductive film 148 may not be formed between the voltage pads 141 and 146.

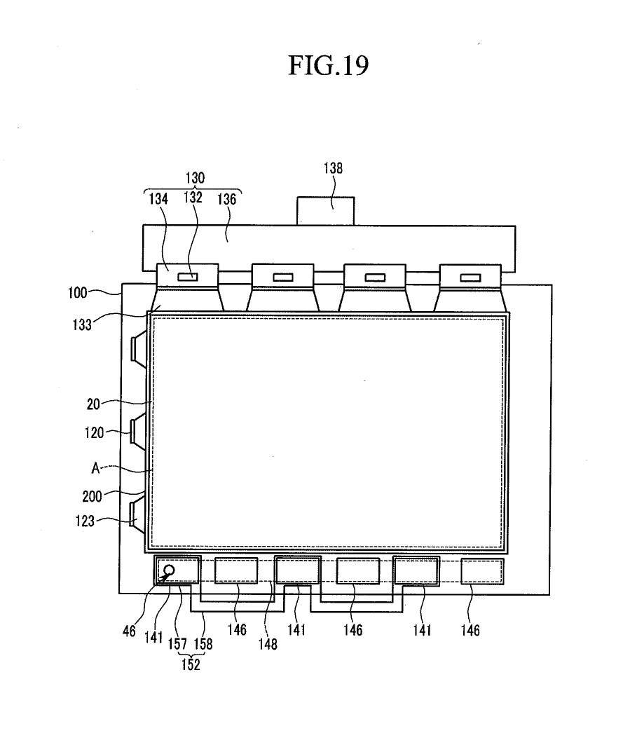

Then, as shown in FIG. 19, the first flexible conductive film 152 is prepared, which includes contact portions 157 that are connected to each other by the bent portion 158 and have substantially the same layout as the driving voltage pad 141, and the first flexible conductive film 152 is formed on the anisotropic conductive film 148 such that the contact portion 157 corresponds to the driving voltage pad 141. At this time, the conductive layer exposing portion 46 where a portion of the insulating layer 40 is removed is formed in the leftmost contact portion 157, and thus a portion of the conductive layer 30 is exposed to the outside through the conductive layer exposing portion 46.

The process of forming the first flexible conductive film 152 on the anisotropic conductive film 148 will be described in detail. First, the first flexible conductive film 152 is disposed on the anisotropic conductive film 148 such that the contact portion 157 corresponds to the driving voltage pad 141. Then, the driving voltage pad 141 and the contact portion 157 are pressurized to be connected to each other with the anisotropic conductive film 148 interposed therebetween, such that the driving voltage pad 141 and the first flexible conductive film 152 are electrically connected to each other.

The conductive particles (not shown) of the anisotropic conductive film 148 that is located between the driving voltage pad 141 and the first flexible conductive film 152 by means of the pressurizing process only contact the driving voltage pad 141 and the first flexible conductive film 152, and the driving voltage pad 141 and the first flexible conductive film 152 are physically and electrically connected to each other with the conductive particles interposed therebetween. However, the anisotropic conductive film 148 that is not located between the driving voltage pad 141 and the first flexible conductive film 152 on which the pressurizing process is not performed maintains an insulating state by an epoxy resin layer having an excellent insulating property. Accordingly, the anisotropic conductive film 148 is not electrically connected in a horizontal direction, and thus an electrically insulated state is maintained between the neighboring voltage pads 141 and 146.

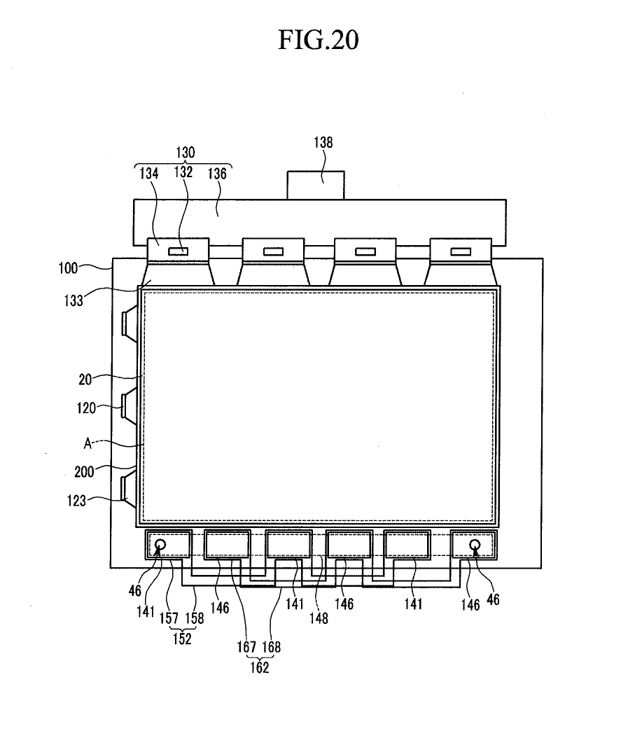

Then, as shown in FIG. 20, in the same method as above, the second flexible conductive film 162 is prepared, which includes contact portions 167 that are connected to each other by the bent portion 168 and have the same layout as the common voltage pad 146, and the second flexible conductive film 162 is formed on the anisotropic conductive film 148 such that the contact portion 167 corresponds to the common voltage pad 146. At this time, the conductive layer exposing portion 46 where a portion of the insulating layer 40 is removed is formed in the rightmost contact portion 167, and thus a portion of the conductive layer 30 is exposed to the outside through the conductive layer exposing portion 46.

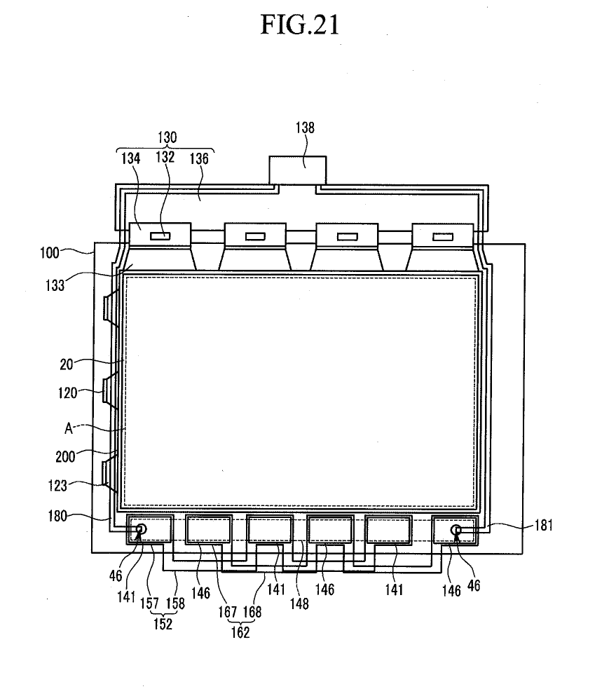

Then, as shown in FIG. 21, the external voltage source input section 138 that applies the driving voltage and the common voltage to the driving voltage pad 141 and the common voltage pad 146, respectively, and the conductive layers 30 of the flexible conductive films 152 and 162 that are exposed through the conductive layer exposing portions 46 are connected to each other by using the metal wiring lines 180 and 181.

Then, the metal wiring lines 180 and 181 that are connected to the conductive layers 30 are fixed by the fixing member 182, thereby completing the organic light emitting diode display shown in FIG. 10.

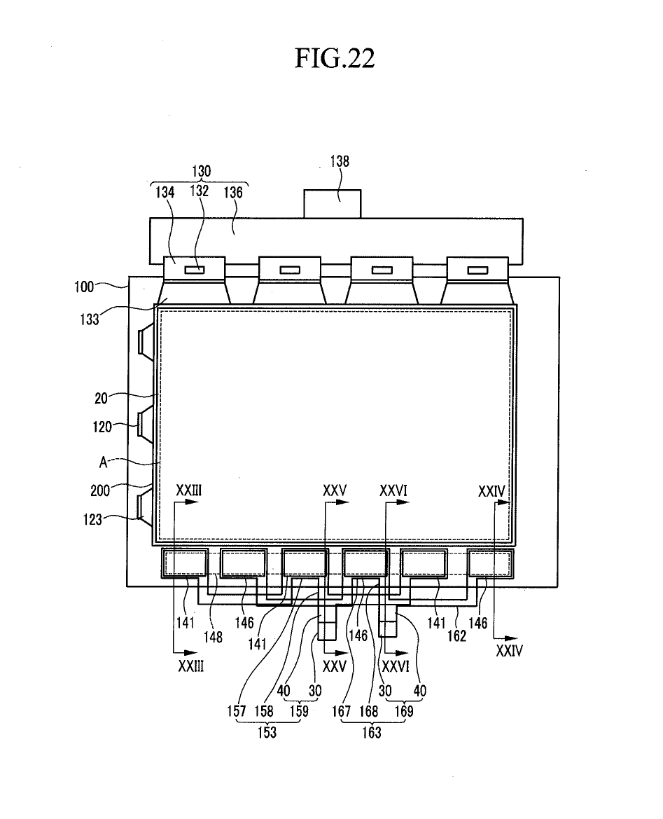

An organic light emitting diode display according to still another exemplary embodiment of the present invention will be described with reference to FIGS. 22 to 26. The differences between the organic light emitting diode display according to this exemplary embodiment of the present invention and the organic light emitting diode display according to the exemplary embodiment of the present invention shown in FIG. 10 will be mainly described.

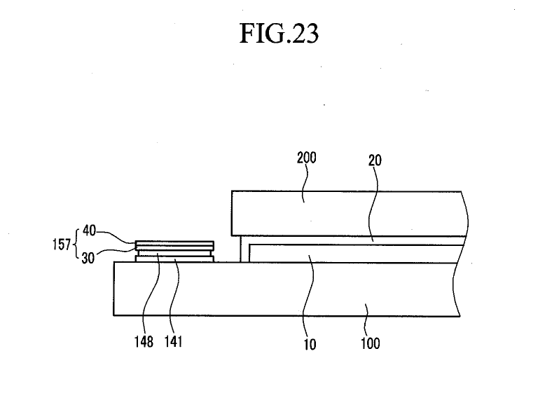

FIG. 22 is a plan view of a display panel of an organic light emitting diode display according to the current exemplary embodiment of the present invention, and FIGS. 23 to 26 are cross-sectional views taken along the lines XXIII-XXIII, XXIV-XXIV, XXV-XXV, and XXVI-XXVI in the organic light emitting diode display shown in FIG. 22.

The organic light emitting diode display shown in FIGS. 22 to 26 includes the contact portions 157 and 167 that have substantially the same layout as the voltage pads 141 and 146 to which the respective flexible conductive films 153 and 163 correspond, the bent portions 158 and 168 that connect the contact portions 157 and 167, and the extending portions 159 and 169 that extend to the outside of the peripheral area from the bent portions 158 and 168. Although not shown, similar to the organic light emitting diode display shown in FIGS. 7 and 9, in addition to the external voltage source input section 138, a separate external voltage source input unit 311, which is directly connected to the extending portions 159 and 169 without using the metal wiring lines 180 and 181 and include connectors 321 and 322, is attached to the corresponding location of the panel cover 300.

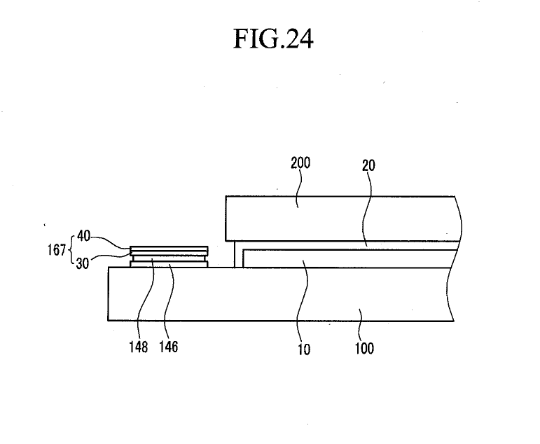

Therefore, as shown in FIGS. 23 and 24, the conductive layer exposing portions 46 are not formed at the leftmost contact portion 157 of the first flexible conductive film 153 and the rightmost contact portion 157 of the second flexible conductive film 163.

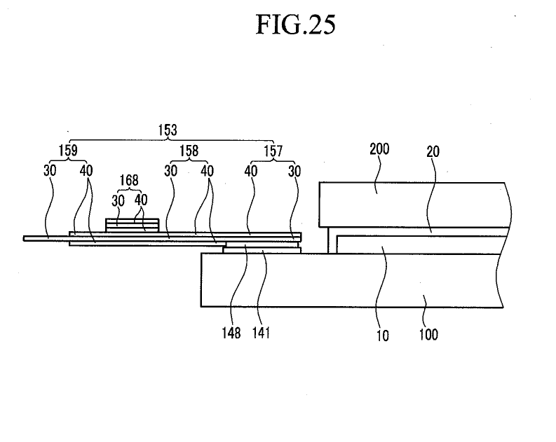

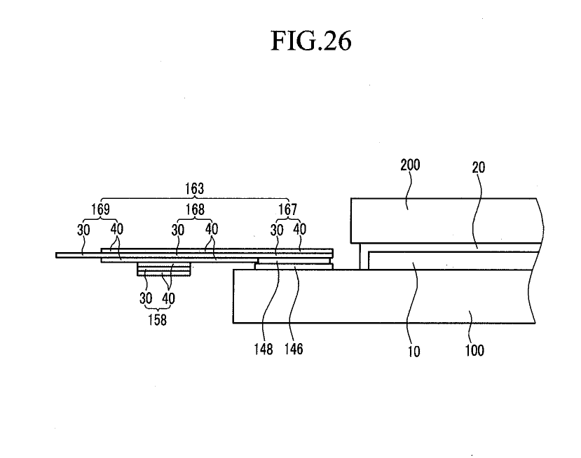

Further, as shown in FIGS. 25 and 26, in the organic light emitting diode display according to the present exemplary embodiment, the bent portion 168 of the second flexible conductive film 163 is laminated on the bent portion 158 of the first flexible conductive film 153. However, the bent portion 158 of the first flexible conductive film 153 may be laminated on the bent portion 168 of the second flexible conductive film 163.

In the portions of the extending portions 159 and 169 of the respective flexible conductive films 153 and 163 that are connected to the bent portions 158 and 168, the top surface and the bottom surface of each of the conductive layers 30 are covered with the insulating layer 40. However, in the ends of the extending portions 159 and 169 that are coupled with the connectors 321 and 322, the insulating layers 40 are removed, and thus the conductive layers 30 are exposed. Accordingly, the exposed conductive layers 30 are removably coupled with the connectors 321 and 322 of the external voltage source input section 311.

The width and length of each of the extending portions 159 and 169 may be changed, if necessary.

Using the organic light emitting diode display shown in FIGS. 22 to 26, it is possible to achieve the same effect as the organic light emitting diode display shown in FIG. 10.

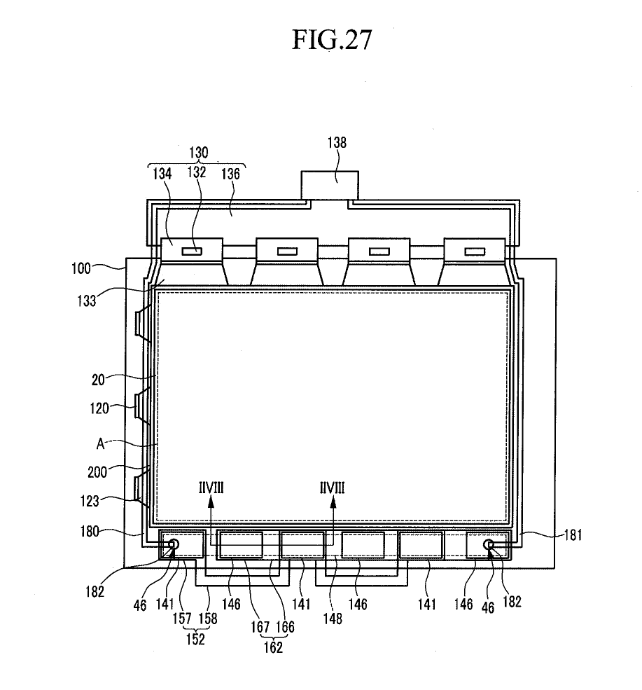

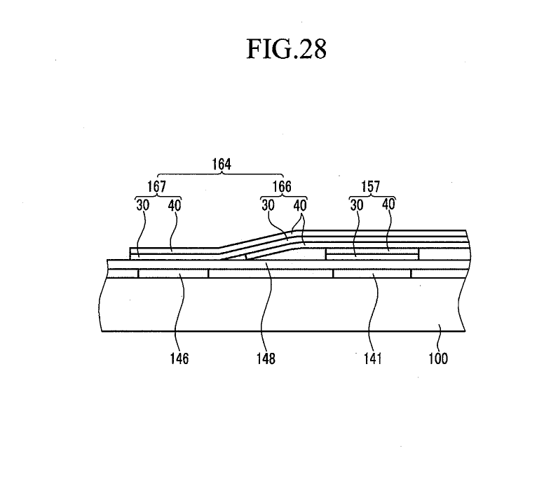

An organic light emitting diode display according to a further exemplary embodiment of the present invention will be described with reference to FIGS. 27 and 28. Only the differences between the organic light emitting diode display shown in FIGS. 27 and 28 and the organic light emitting diode display shown in FIG. 10 will be mainly described.

FIG. 27 is a plan view of an organic light emitting diode display according to the current exemplary embodiment of the present invention, and FIG. 28 is a cross-sectional view taken along the line XXVIII-XXVIII in the organic light emitting diode display shown in FIG. 27.

The organic light emitting diode display shown in FIGS. 27 and 28 is the same as the organic light emitting diode display shown in FIG. 10, except that the second flexible conductive film 164 includes a plurality of contact portions 167 each having substantially the same layout as the common voltage pad 146 and connecting portions 166 that linearly connect the plurality of contact portions 167, and the structure of the organic light emitting diode display is further simplified.

The portion of the connecting portion 166 of the second flexible conductive film 164 is laminated on the contact portion 157 of the first flexible conductive film 152. However, since the connecting portion 166 and the contact portion 157 are electrically insulated from each other by the insulating layers 40, electrical interference between the connecting portion 166 and the contact portion 157 does not occur.

Meanwhile, the shapes of the first flexible conductive film 152 and the second flexible conductive film 164 may be changed with each other, and the first flexible conductive film 152 and the second flexible conductive film 164 may be connected to the corresponding voltage pads 141 and 146.

If using the organic light emitting diode display shown in FIGS. 27 and 28, it is possible to achieve the same effect as with the organic light emitting diode display shown in FIG. 10.

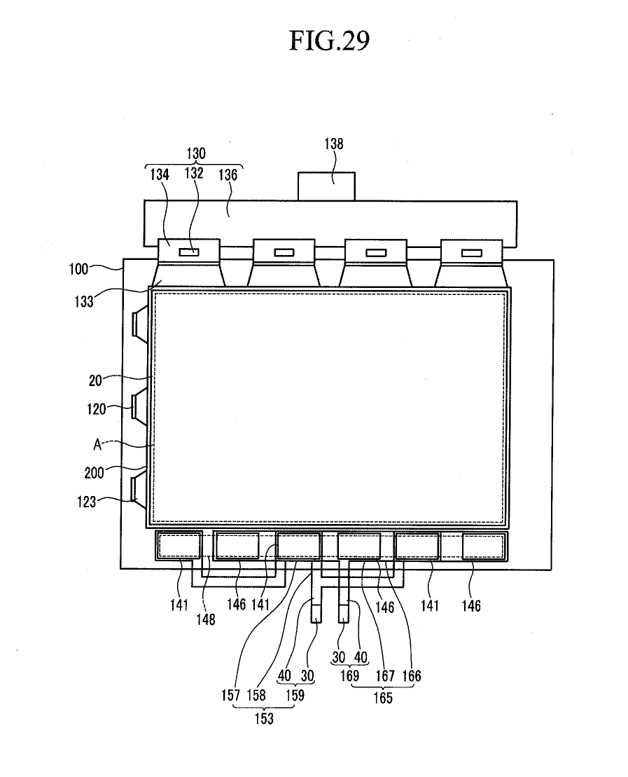

An organic light emitting diode display according to a still further exemplary embodiment of the present invention will be described with reference to FIG. 29. At this time, the differences between the current organic light emitting diode display and the organic light emitting diode display shown in FIG. 22 will be mainly described.

FIG. 29 is a plan view of a display panel of an organic light emitting diode display according to the current exemplary embodiment of the present invention.

The organic light emitting diode display shown in FIG. 29 is the same as the organic light emitting diode display shown in FIG. 22, except that the extending portion 169 of the second flexible conductive film is connected directly to the contact portion 167 instead of the bent portion 168.

Meanwhile, different from the present exemplary embodiment, the extending portion 169 of the second conductive film is not connected directly to the contact portion 167, but may extend to the outside of the peripheral area from the connecting portion 166.

If using the organic light emitting diode display shown in FIG. 29, it is possible to achieve the same effect as with the organic light emitting diode display shown in FIG. 22.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An organic light emitting diode display comprising:
a display panel that includes a display region where a plurality of thin film transistors and a plurality of emission layers are formed, and a peripheral area formed along the circumference of the display area;
voltage pads formed in the peripheral area for applying at least one of a driving voltage and a common voltage to the display region;
an anisotropic conductive film formed on the voltage pads; and
a flexible conductive film that includes contact portions, each of which is formed on a corresponding portion of the anisotropic conductive film, the conductive film having a conductive layer and an insulating layer covering the conductive layer.

2. The organic light emitting diode display of claim 1, wherein the conductive films comes into contact with the anisotropic conductive film in the contact portions.

3. The organic light emitting diode display of claim 1, wherein the width of the flexible conductive film is in a range of 1 to 10 mm.

4. The organic light emitting diode display of claim 1, further comprising an external voltage source input section that applies at least one of the driving voltage and the common voltage to the voltage pads through the conductive layers.

5. The organic light emitting diode display of claim 4, wherein the insulating layer is provided with a conductive layer exposing portion that exposes a portion of the conductive layer to the outside.

6. The organic light emitting diode display of claim 5, further comprising:
metal wiring lines each having one end connected to the external voltage source input section and the other end connected to the conductive layer through the conductive layer exposing portion; and
fixing members that fix the other ends of the metal wiring lines on the conductive layers.

7. The organic light emitting diode display of claim 6, wherein the external voltage source input section is provided in the peripheral area and is connected to a circuit board that generates a display signal.

8. The organic light emitting diode display of claim 1, wherein the flexible conductive film further includes extending portions that extend to the outside of the peripheral area from the contact portions.

9. The organic light emitting diode display of claim 8, wherein each of the extending portions extends to the outside of the peripheral area with substantially the same length as the length of the corresponding contact portion.

10. The organic light emitting diode display of claim 4, wherein:
the flexible conductive film further includes extending portions that extend to the outside of the peripheral area from the contact portions;
at some least portions of the conductive layers are exposed to the outside in the extending portions; and
the external voltage source input section includes connectors that are removably coupled with the conductive layers exposed to the outside at the extending portions.

11. An organic light emitting diode display comprising:
a display panel that includes a display area where a plurality of thin film transistors and a plurality of emission layers are formed, and a peripheral area formed along the circumference of the display area;
a plurality of driving voltage pads and a plurality of common voltage pads alternately formed at predetermined intervals along the peripheral area of at least one side of the display area;
an anisotropic conductive film formed on the driving voltage pads and the common voltage pads;
a first flexible conductive film formed on the anisotropic conductive film that includes a plurality of first contact portions each having a first conductive layer and a first insulating layer covering the first conductive layer and having substantially the same layout as one of the driving voltage pads and the common voltage pads and a first bent potion connecting the plurality of first bent portions and bent to the outside of the peripheral area; and
a second flexible conductive film formed on the anisotropic conductive film that includes a plurality of second contact portions each having a second conductive layer and a second insulating layer covering the second conductive layer and having substantially the same layout as the other of the driving voltage pads and the common voltage pads.

12. The organic light emitting diode display of claim 11, wherein the second flexible conductive film further includes a second bent portion that connects the plurality of second contact portions and is bent to the outside of the peripheral area.

13. The organic light emitting diode display of claim 11, wherein the second flexible conductive film further includes connecting portions that linearly connect the plurality of second contact portions along the peripheral area.

14. The organic light emitting diode display of claim 13, wherein the connecting portions are disposed on the first contact portions.

15. The organic light emitting diode display of claim 11, wherein the first conductive layer and the second conductive layer come into contact with the anisotropic conductive film at the first contact portion and the second contact portion, respectively.

16. The organic light emitting diode display of claim 15, wherein the width of each of the first contact portion and the second contact portion is in a range of 1 to 10 mm.

17. The organic light emitting diode display of claim 12, wherein:
both surfaces of the first conductive layer are covered with the first insulating layer at the first bent portion; and
both surfaces of the second conductive layer are covered with the second insulating layer at the second bent portion.

18. The organic light emitting diode display of claim 12, further comprising
an external voltage source input section that applies a driving voltage and a common voltage to the respective driving voltage pads and the respective common voltage pads through the first and second conductive layers.

19. The organic light emitting diode display of claim 18, wherein:
in at least one among the plurality of first contact portions, the first insulating layer is provided with a first conductive layer exposing portion that exposes a portion of the first conductive layer to the outside; and
in at least one of the plurality of second contact portions, the second insulating layer is provided with a second conductive layer exposing portion that exposes a portion of the second conductive layer to the outside.

20. The organic light emitting diode display of claim 19, further comprising:
first metal wiring lines each having one end connected to the external voltage source input section and the other end connected to the first conductive layer through the first conductive layer exposing portion;
second metal wiring lines each having one end connected to the external voltage source input section and the other end connected to the second conductive layer through the second conductive layer exposing portion; and
fixing members that fix the other ends of the first and the second metal wiring lines on the first and second conductive layers, respectively.

21. The organic light emitting diode display of claim 20, wherein the external voltage source input section is disposed in the peripheral area, and is connected to a circuit board that generates a display signal.

22. The organic light emitting diode display of claim 18, wherein:
the first flexible conductive film further includes a first extending portion that extends to the outside of the peripheral area from the first bent portion;
and the second flexible conductive film further includes a second extending portion that extends to the outside of the peripheral area from the second bent portion.

23. The organic light emitting diode display of claim 22, wherein:
at least one portion of the first conductive layer is exposed to the outside at the first extending portion; and
at least one of the second conductive layer is exposed to the outside at the second extending portion.

24. The organic light emitting diode display of claim 23, wherein the external voltage source input section includes connectors that are removably coupled with the first and second conductive films exposed to the outside at the first and second extending portions, respectively.

25. An organic light emitting diode display comprising:
a display panel having a display area including a plurality of thin film transistors and a plurality of emission layers and a peripheral area along the circumference of the display area;
voltage pads formed in the peripheral area for applying at least one of a driving voltage and a common voltage to the display area;
an anisotropic conductive film formed on the voltage pads; and
a flexible conductive film formed on the anisotropic conductive film that includes a conductive layer having a thickness in a range of 1 to 3000 μm and an insulating layer covering the conductive layer.

26. A method of forming an organic light emitting diode display, the method comprising:
forming in a peripheral area along the circumference of the display a plurality of voltage pads for applying at least one of a driving voltage and a common voltage;
forming an anisotropic conductive film on the voltage pads;
forming a flexible conductive film including contact portions on the anisotropic conductive film, each of the contact portions having a conductive layer and an insulating layer covering the conductive layer, such that the contact portions correspond to respective ones of the voltage pads.
A method of forming an organic light emitting diode display, the method comprising:
forming in a peripheral area along the circumference of the display a plurality of voltage pads for applying at least one of a driving voltage and a common voltage;
forming an anisotropic conductive film on the voltage pads;
forming a flexible conductive film including contact portions on the anisotropic conductive film, each of the contact portions having a conductive layer and an insulating layer covering the conductive layer, such that the contact portions correspond to respective ones of the voltage pads.

27. The method of claim 26, wherein the forming of the flexible conductive film on the anisotropic conductive film includes:
disposing the flexible conductive film on the anisotropic conductive film such that the contact portions correspond to the respective voltage pads; and
pressurizing the voltage pads and the contact portions with the anisotropic conductive film interposed therebetween, such that the voltage pads and the flexible conductive film are electrically connected to each other.

28. The method of claim 26, wherein the connecting of the flexible conductive film to the external voltage source input section includes forming metal wiring lines each having one end connected to the external voltage source input section and the other end connected the conductive layer of the flexible conductive film.

29. The method of claim 26, wherein the flexible conductive film further includes extending portions that extend to the outside of the peripheral area from the contact portions.

30. The method of claim 29, wherein the external voltage source input section further includes connectors that are removably coupled with the extending portions.

31. The method of claim 26, wherein
the voltage pads include a plurality of driving voltage pads and a plurality of common voltage pads that are alternately formed at predetermined intervals along the peripheral area of at least one side of the display area, and
the forming of the flexible conductive film on the anisotropic conductive film includes:
preparing a first flexible conductive film including a plurality of first contact portions, each having a first conductive layer and a first insulating layer covering the first conductive layer and having substantially the same layout as one of the driving voltage pads and the common voltage pads, and a first bent portion connecting the plurality of first contact portions and bent to the outside of the peripheral area so as to form the first flexible conductive film on the anisotropic conductive film, such that the first contact portions correspond to one of the driving voltage pads and the common voltage pads; and
preparing a second flexible conductive film including a plurality of second contact portions, each having a second conductive layer and a second insulating layer covering the second conductive layer and having substantially the same layout as the other of the driving voltage pads and the common voltage pads, so as to form the second flexible conductive film on the anisotropic conductive film, such that the second contact portions correspond to the other of the driving voltage pads and the common voltage pads.

32. The method of claim 31, wherein the connecting of the flexible conductive film to the external voltage source input section includes preparing an external voltage source input section applying a driving voltage and a common voltage to the driving voltage pads and the common voltage pads so as to connect the first flexible conductive film and the second flexible conductive film to the external voltage source input section.

33. The method of claim 31, wherein the forming of the first flexible conductive film on the anisotropic conductive film includes:
disposing the first flexible conductive film on the anisotropic conductive film such that the first contact portion corresponds to one of the driving voltage pad and the common voltage pad; and
pressurizing one of the driving voltage pad and the common voltage pad and the first contact portion with the anisotropic conductive film interposed therebetween, such that the first flexible conductive film is electrically connected to one of the driving voltage pad and the common voltage pad.

34. The method of claim 33, wherein the forming of the second flexible conductive film on the anisotropic conductive film includes:
disposing the second flexible conductive film on the anisotropic conductive film such that the second contact portion corresponds to the other of the driving voltage pad and the common voltage pad; and
pressurizing the other of the driving voltage pad and the common voltage pad and the second contact portion with the anisotropic conductive film interposed therebetween, such that the second flexible conductive film is electrically connected to one of the driving voltage pad and the common voltage pad.

35. The method of claim 32, wherein the connecting of the first flexible conductive film and the second flexible conductive film to the external voltage source input section includes:
preparing first metal wiring lines each having one end connected to the external voltage source input section and the other end connected to the first conductive layer of the first flexible conductive film; and
preparing second metal wiring lines each having one end connected to the external voltage source input section and the other end connected to the second conductive layer of the second flexible conductive film.

36. The method of claim 31, wherein the second flexible conductive film further includes a second bent portion that connects the plurality of second contact portions and is bent to the outside of the peripheral area.

37. The method of claim 31, wherein the second flexible conductive film further includes connecting portions that linearly connect the plurality of second contact portions along the peripheral area.

38. The method of claim 37, wherein the connecting portion is disposed on the first contact portion.

39. The method of claim 36, wherein:
the first flexible conductive film further includes a first extending portion that extends to the outside of the peripheral area from the first bent portion, and
the second flexible conductive film further includes a second extending portion that extends to the outside of the peripheral area from the second bent portion.

40. The method of claim 39, wherein the external voltage source input section further includes connectors that are removably coupled with the first extending portion and the second extending portion.
